(19) United States
(12) Patent Application Publication
(10) Pub. No.: US 2014/0019521 A1
(43) Pub. Date: Jan. 16, 2014

(54) TERMINAL APPARATUS AND COMPUTER READABLE MEDIUM

(71) Applicant: Casio Computer Co., Ltd., Tokyo (JP)

(72) Inventors: Tsuyoshi Ohsumi, Tokyo (JP); Keiichi Tanioka, Tokyo (JP)

(21) Appl. No.: 13/930,425

(22) Filed: Jun. 28, 2013

(30) Foreign Application Priority Data
Jul. 12, 2012 (JP) 2012-156057

(51) Int. Cl. H04L 29/06

(52) U.S. Cl. CPC H04L 67/42
USPC 709/203

(57) ABSTRACT

Disclosed is a terminal apparatus including a communication unit which performs a wireless communication with another terminal apparatus and a determination unit which determines whether a terminal apparatus which is a sub terminal into, which data subject to copying is to be copied, exists through the communication via the communication unit, the terminal apparatus which is the sub terminal being a terminal apparatus to which the data is not yet transmitted, if the terminal apparatus is a main terminal from which the data is copied. Further including a control unit which reads out the data from a storage unit and transmits the data to the terminal apparatus which is the sub terminal determined to exist via the communication unit if the determination unit determines that the terminal apparatus which is the sub terminal exists.

### BACKGROUND OF THE INVENTION

1. Field of the Invention

The present invention relates to a terminal apparatus and a computer readable medium.

2. Description of Related Art

Conventionally, there are cases where a supplier of terminal apparatuses such as handy-terminals supplies a client with a plurality of same terminal apparatuses. In these cases, the number of terminal apparatuses to be supplied may reach few hundred. In such cases, the terminal apparatuses are set-up, one by one, by workers following the procedure (1) to (4) described below. Here, the terminal apparatus which transmits data is the main terminal and the terminal apparatuses which receive data are the sub terminals.

The procedure is as follows:

(1) Make a terminal apparatus which is to become a main terminal be in an operable state. In particular, install application programs and set various types of settings in the main terminal.

(2) Create a back-up image file as main terminal data.

(3) Copy the back-up image file of the main terminal into a sub terminal.

(4) Open the back-up image file in the sub terminal and prepare the sub terminal as a copy of the main terminal.

In the above procedure, it is required to set a way for data transmission between the main terminal and a sub terminal when copying the back-up image file in step (3). For example, data transmission needs to be performed via a medium such as a SD (Secure Digital) card between the main terminal and a sub terminal or by connecting the main terminal and a sub terminal with a wire such as USB (Universal Serial Bus). Alternatively, a wireless LAN communication environment has to be established by setting up an access point in order to connect the main terminal and a sub terminal with a wireless LAN (Local Area Network). Thus, workers require a special knowledge and experiences.

Moreover, a worker who manages/looks over the above procedures needs to be appointed at all times. Therefore, the human resource cost increases. Further, human errors such as operational errors and work errors while handling the back-up image file may occur leading to security issues.

As one method for solving the above problem, there is known a method to automatically update the data stored in a plurality of terminal apparatuses to the update data at once (see JP 2009-89259). In particular, updating path information indicating a tandem or tree-shaped transmission path to transmit the update data to the plurality of terminal apparatuses is created in advance and is stored in all of the terminal apparatuses. Then, the terminal apparatuses sequentially send the update data through a wireless communication based on the updating path information to update data.

In JP 2009-89259, there is no need for a worker to monitor the operation; however, a path creating operation to figure out and create the transmission path for the update data in advance is required. It is preferred that the transmission path is created so that data transmission and updating can be performed efficiently. Thus, a great work load is needed for creating the path and this can lead to occurrence of errors in creating the transmission path.

Moreover, in the above method, the transmission path is tandem or tree-shaped and the terminal apparatus assigned to transmit data which has completed the data transmission to a subsequent terminal apparatus assigned to receive data is not effectively used so as not to transmit the update data. Thus, there is a possibility that the time period required for updating the data is to be long.

### SUMMARY OF THE INVENTION

An object of the present invention is to reduce the work load of workers and shorten the data copy time period when copying the same data into a plurality of terminal apparatuses.

According to one aspect of the present invention, a terminal apparatus includes a communication unit which performs a wireless communication with another terminal apparatus, a determination unit which determines whether a terminal apparatus which is a sub terminal into which data subject to copying is to be copied exists through the communication via the communication unit, the terminal apparatus which is the sub terminal being a terminal apparatus into which the data is not yet transmitted, if the terminal apparatus is a main terminal from which the data is copied, and a control unit which reads out the data from a storage unit and transmits the data to the terminal apparatus which is the sub terminal determined to exist via the communication unit if the determination unit determines that the terminal apparatus which is the sub terminal exists, and processing from determination of existence of the terminal apparatus which is the sub terminal by the determination unit to transmission of the data by the control unit is repeatedly performed.

According to another aspect of the present invention, a non-transitory computer readable medium which stores a program for making a computer execute a process, the process includes performing a wireless communication between a terminal apparatus and another terminal apparatus, if the terminal apparatus is a main terminal from which data is copied, determining whether a terminal apparatus which is a sub terminal into which the data subject to copying is to be copied exist through the communication with the another terminal apparatus, the terminal apparatus which is the sub terminal being a terminal apparatus into which the data is not yet transmitted, if the terminal apparatus which is the sub terminal is determined to exist, reading the data from a storage unit and transmitting the data to the terminal apparatus which is the sub terminal determined to exist, and repeatedly performing processing from the determining whether the terminal apparatus which is the sub terminal exists to the transmitting of the data.

According to the present invention, the work load of a worker can be reduced and the data copy time period can be shortened when the same data is to be copied into a plurality of terminal apparatuses.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a block diagram showing the first terminal management system according to the first embodiment of the present invention;

FIG. 2 is a block diagram showing a functional configuration of a terminal apparatus;

FIG. 3 is a flowchart showing the first data copying process;

FIG. 4 is a time chart of a data transmission procedure performed in the first terminal management system;

FIG. 5 is a block diagram showing the second terminal management system according to the second embodiment of the present invention;

FIG. 6 is a flowchart showing the second data copying process;

FIG. 7A is a time chart of a data transmission procedure performed in the first terminal apparatus group;

FIG. 7B is a time chart of data transmission procedure performed in the second terminal apparatus group;

FIG. 8 is a block diagram showing the third terminal management system according to the third embodiment of the present invention;

FIG. 9 is a flowchart showing the third data copying process;

FIG. 10A is a diagram showing the third terminal management system during data copying; and

FIG. 10B is a diagram showing the third terminal management system when data copying is completed.

### DESCRIPTION OF THE PREFERRED EMBODIMENTS

Hereinafter, the first to third embodiments of the present invention will be described in detail with reference to the drawings. However, the present invention is not limited to the examples shown in the drawings.

### First Embodiment

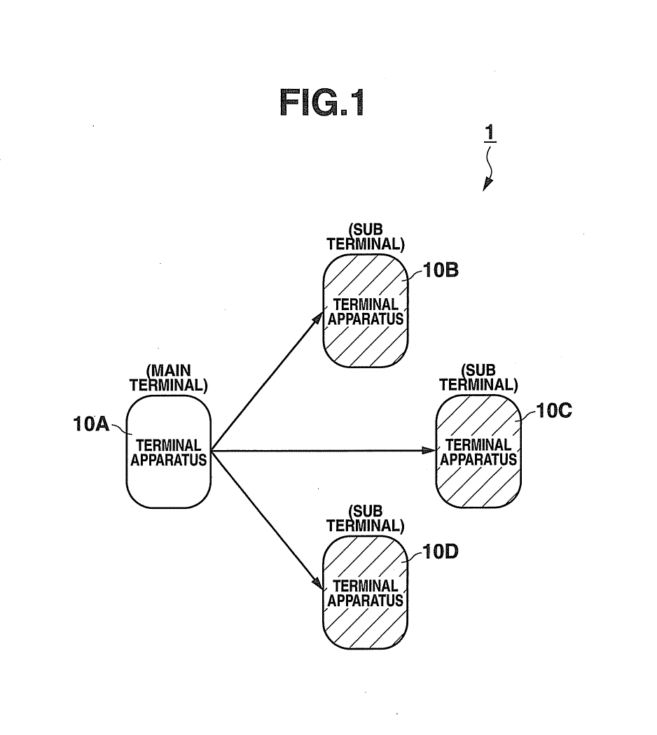

The first embodiment of the present invention will be described with reference to FIGS. 1 to 4.

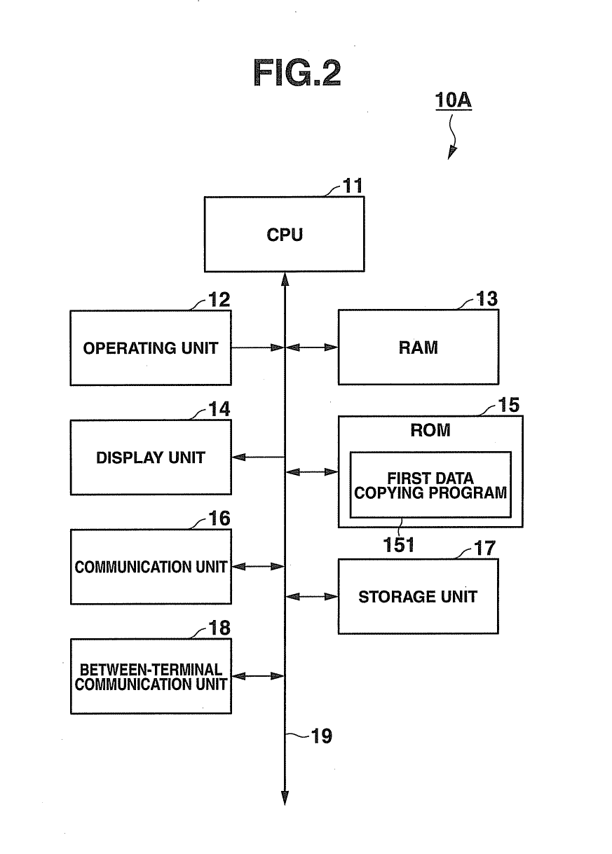

First, the apparatus configuration according to the embodiment will be described with reference to FIGS. 1 and 2.

FIG. 1 is a block diagram showing the terminal management system 1 according to the first embodiment, and FIG. 2 is a block diagram showing the functional configuration of the terminal apparatus 10A.

The terminal management system 1 is a system used by a supplier of terminal apparatuses or a user who operates a plurality of terminal apparatuses and is a system for copying and storing the same data into the entire terminal apparatuses included in the terminal management system 1.

A supplier is to deliver a plurality of terminal apparatuses in which the same data is stored, the data being created by the terminal management system 1, to a client. A user (for example, a business person) who operates a plurality of terminal apparatuses makes a plurality of employees use the plurality of terminal apparatuses in which the same data is stored, the data being created by the terminal management system 1.

As shown in FIG. 1, the terminal management system 1 includes terminal apparatuses 10A, 10B, 10C and 10D.

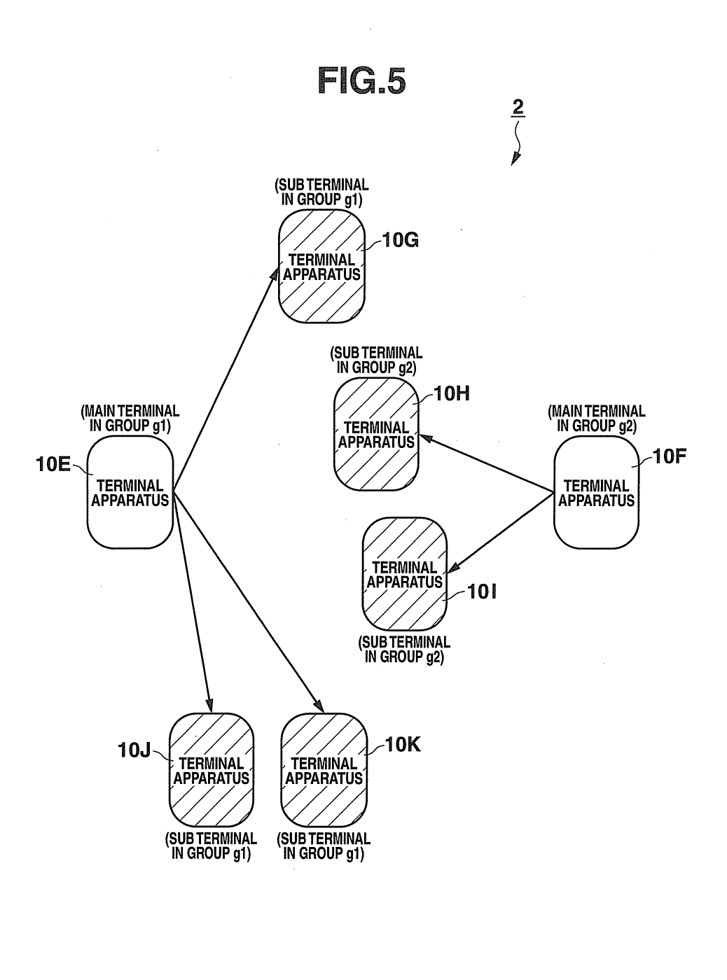

In FIG. 1, the terminal apparatus which is the main terminal is in white color and the terminal apparatuses which are the sub terminals are in gray color (shaded). This is the same in FIGS. 5, 8 and 10.

The terminal apparatuses 10A, 10B, 10C and 10D are handy-terminals as terminal apparatuses which collect information, though they are not limited to such handy-terminals. The terminal apparatuses 10A, 10B, 10C and 10D may be other terminal apparatuses such as PDAs (Personal Digital Assistant), tablet PCs (Personal Computer) or the like. This is the same with the terminal apparatuses in other embodiments.

The terminal apparatus from which data is to be copied is set as the main terminal and the terminal apparatuses to which the copied data is to be copied into are set as the sub terminals. In the terminal management system 1, the terminal apparatus 10A is the main terminal and the terminal apparatuses 10B, 10C and 10D are the sub terminals.

The number of main terminal is not limited to one and there may be a plurality of main terminals. However, if there are a plurality of main terminals, the data to be copied from the main terminals and copied into the sub terminals is to be the same data among the main terminals.

The number of sub terminals is not limited to three. Further, the number of terminal apparatuses included in the terminal management system 1 is not limited to four.

The same data to be copied into the sub terminals from the main terminal is a back-up file of the main terminal; however, the data is not limited to such back-up file.

Next, the functional configuration in each of the terminal apparatuses 10A, 10B, 10C and 10D will be described with reference to FIG. 2. Here, the configuration of the terminal apparatus 10A will be described as a representative; however, the similar configuration applies to the terminal apparatuses 10B, 10C and 10D.

As shown in FIG. 2, the terminal apparatus 10A includes a determination unit, a CPU (Central Processing Unit) 11 as a control unit, an operating unit 12 as the first, second and third operating units, a RAM (Random Access Memory) 13, a display unit 14, a ROM (Read Only Memory) 15, a communication unit 16, a storage unit 17 and an between-terminal communication unit 18. The components in the terminal apparatus 10A are connected to one another through a bus 19.

The CPU 11 controls each part in the terminal apparatus 10A. The CPU 11 reads out a specified program among the various types of programs from the ROM 15 and opens the read program in the RAM 13 to execute various processes in cooperation with the opened program.

If the terminal apparatus 10A is the main terminal, the CPU 11 follows the first data copying program 151 and searches for terminal apparatuses which can communicate, determines whether terminal apparatuses which are the sub terminals having a tentative terminal name exist among the detected terminal apparatuses, and transmits data which is subject for copying by performing paring with the terminal apparatuses which are the sub terminals confirmed to exist via the between-terminal communication 18. The CPU 11 repeatedly performs the processing from searching of terminal apparatuses to data transmission.

If the terminal apparatus 10A is the sub terminal, the CPU 11 receives data from the terminal apparatus which is the main terminal via the between-terminal communication unit 18 and stores the data in the storage unit 17.

The operating unit 12 includes a group of keys such as letter input keys and function keys. The operating unit 12 receives pushing inputs performed on the keys by a user and outputs the operation information corresponding to the pushing inputs to the CPU 11. If the terminal apparatus 10A includes a scanner unit, the operating unit 12 includes a trigger key for scanning to be performed by the scanner unit.

Further, the operating unit 12 may be configured to include a touch panel provided on the screen of the display unit 14 and receive touch inputs performed by a user.

The RAM 13 is a volatile semiconductor memory and includes a work area for storing various types of data and various types of programs.

The display unit 14 is a display unit provided with a display panel such as a LCD (Liquid Crystal Display) or an EL (Electro Luminescent) display and performs various types of displays on the display panel according to the display information input from the CPU 11.

The ROM 15 is a read only semiconductor memory in which various types of data and various types of programs are stored. The first data copying program 151 is stored in the ROM 15.

The communication unit 16 is a wireless communication unit which performs a wireless LAN communication. For example, an access point (not shown in the drawings) is set up in a store where the terminal apparatuses 10A, 10B, 10C and 10D are used, and the communication unit 16 of each of the terminal apparatuses 10A, 10B, 10C and 10D carries out a wireless communication with the access point to communicate with a device such as a server in the store via the access point.

The communication unit 16 may include a communication unit which carries out a wired communication such as USB or LAN via a cradle. The communication by the communication unit 16 is not carried out in the first data copying process.

The storage unit 17 is a non-volatile memory such a flash memory, EEPROM (Electrically Erasable Programmable ROM) or a RAM backed up with a battery where information is readable and writable.

The between-terminal communication unit 18 is a communication unit using Bluetooth (registered trademark) communication format which enables close distance wireless communication between devices. By the between-terminal communication unit 18, direct wireless communication is possible between the terminal apparatuses 10A, 10B, 10C and 10D.

Moreover, the terminal apparatus 10A may include a scanner unit such as a laser scanner or an imager which reads symbols, a reader/writer unit for RFID (Radio Frequency Identification) tag, a print unit and the like as functional units of the handy-terminal which are not shown in the drawings. Further, the terminal apparatus 10A includes a power source unit (not shown in the drawings) such as a secondary battery or a primary battery which supplies power to each part in the terminal apparatus 10A.

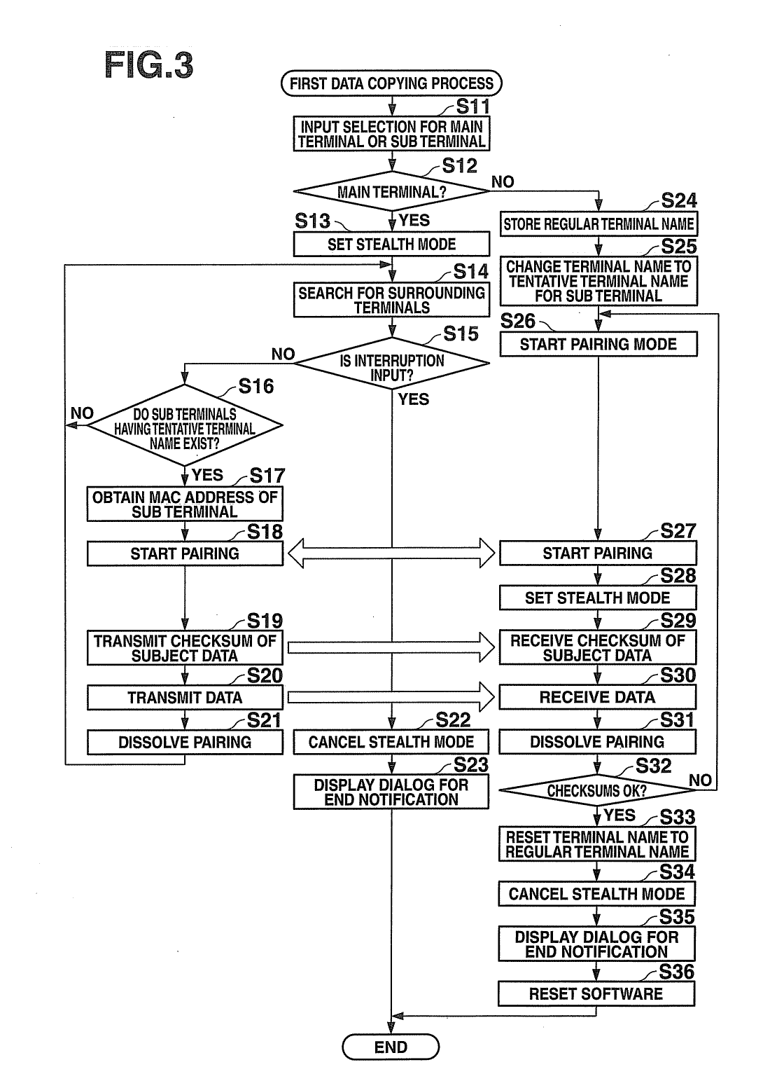

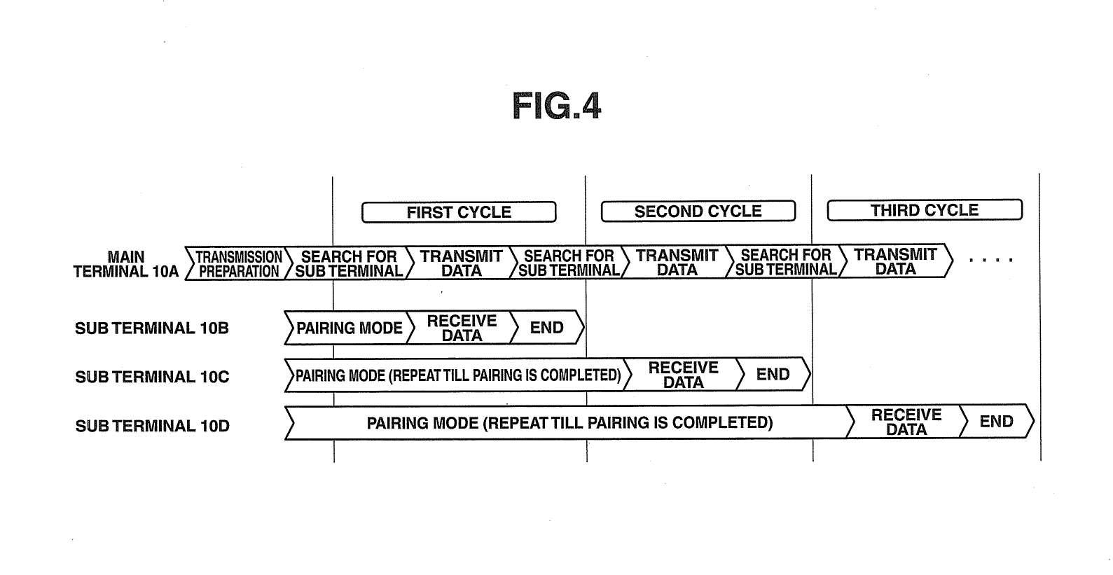

Next, operation of the terminal management system 1 will be described with reference to FIGS. 3 and 4.

FIG. 3 is a flowchart showing the first data copying process. FIG. 4 is a time chart of the data transmission procedure performed in the terminal management system 1.

The first data copying process which is executed in each terminal apparatus in the terminal management system 1 will be described. The first data copying process is a process for transmitting and copying the data in the terminal apparatus which is the main terminal into the terminal apparatuses which are the sub terminals. The case where the first data copying process is executed in the terminal apparatus 10A will be described as an example; however, the first data copying process is similarly executed in the terminal apparatuses 10B, 10C and 10D.

In advance, application programs are installed and various types of settings are set in the terminal apparatus which is the main terminal according to operation inputs performed by a delivery worker on the operating unit 12 so that the terminal apparatus which is the main terminal is set-up to be operable, and a back-up image file is created as the data of the terminal apparatus which is the main terminal and is stored in the storage unit 17.

It is assumed that the terminal apparatus 10A, 10B, 10C and 10D are arranged at positions where they can communication with one another. The communication range of Bluetooth (registered trademark) communication format is between few meters to few dozens of meters. Further, it is assumed that the terminal names (BT (BlueTooth (registered trademark)) name) of the terminal apparatuses 10A, 10B, 10C and 10D are set to “Windows (registered trademark) CE”, for example, as preset regular terminal names, and it is assumed that the tentative terminal mane for sub terminals at the time of data copying is preset to “HT_1”, for example.

In the terminal apparatus 10A, input of execution instruction of the first data copying process performed by a worker on the operating unit 12 being the trigger, the CPU 11 executes the first data copying process in cooperation with the first data copying program 151 which is read out from the ROM 15 and opened in the RAM 13. During when the first data copying process is executed in the terminal apparatus 10A which is the main terminal, the first data copying process is also executed in the terminal apparatuses 10B, 10C and 10D which are the sub terminals.

As shown in FIG. 3, first, the CPU 11 receives a selection input indicating whether the terminal apparatus 10A itself is to be used as the main terminal or a sub terminal, the selection input being performed by a worker on the operation unit 12 (step S11).

Then, the CPU 11 determines whether the terminal apparatus 10A itself is selected to be used as the main terminal in step S11 (step S12). If the terminal apparatus 10A is selected to be used as the main terminal (step S12; YES), the CPU 11 sets the communication mode of the between-terminal communication unit 18 to the stealth mode (step S13). The stealth mode is a mode where a response is not given to a communication request from a device other than the device which is paired.

Then, the CPU 11 searches for terminal apparatuses around the terminal apparatus 10A itself that can communication through communication via the between-terminal communication unit 18 (step S14).

In step S14, the CPU 11 receives and obtains the terminal names of the detected terminal apparatuses. Then, the CPU 11 determines whether the operation input to interrupt the data copying process is received via the operating unit 12 by a worker operating on the operating unit 12 (step S15).

The operation input for interruption of step S15 is performed after data copying is completed in all of the terminal apparatuses which are sub terminals. If the operation input for interruption is not performed (step S15; NO), the CPU 11 determines whether sub terminals having the predetermined tentative name (“HT_1”) exist among the terminal apparatuses detected in step S14 (step S16).

If there is no sub terminal having the tentative terminal name (step S16; NO), the process proceeds to step S14.

If the sub terminals having the tentative terminal name exist (step S16; YES), the CPU 11 receives and obtains the MAC (Media Access Control) address from one terminal apparatus which is a sub terminal among the sub terminals determined to exist having the tentative terminal name via the between-terminal communication unit 18 (step S17).

Then, the CPU 11 uses the MAC address obtained in step S17 through communication by the between-terminal communication unit 18 to request paring with the terminal apparatus having the MAC address and starts paring (step S18). Then, the CPU 11 reads out the data (the back-up image file of the terminal apparatus 10A itself), which is subject to copying, stored in the storage unit 17, calculates the check-sum of MD (Message Digest Algorithm) 5 or the like of the data and transmits the calculated checksum to the terminal apparatus which is the sub terminal with which the terminal apparatus 10A is paired through the between-terminal communication unit 18 (step S19).

Then, the CPU 11, transmits the data which is read out in step S19 to the terminal apparatus which is the sub terminal with which the terminal apparatus 10A itself is paired via the between-terminal communication unit 18 (step S20). Thereafter, the CPU 11 dissolves the pairing which started in step S18 through communication by the between-terminal communication unit 18 (step S21) and the process proceeds to step S14.

If the operation input for interruption is performed (step S15; YES), the CPU 11 cancels the stealth mode which is set in step S13 (step S22). Then, the CPU 11 displays a dialog notifying the end of the first data copying process in the display unit 14 (step S23) and the first data copying process ends.

If the terminal apparatus 10A is not selected to be the main terminal (step S12; NO), the terminal apparatus 10A is selected to be the sub terminal and the CPU 11 stores the preset terminal name (“Windows (registered trademark) CE”) in the storage unit 17 (step S24). Then, the CPU 11 changes the terminal name of the terminal apparatus 10A itself to the predetermined tentative terminal name (“HT_1”) (step S25).

Thereafter, the CPU 11 sets the communication mode of the between-terminal communication unit 18 to the paring mode (step S26). Then, the CPU 11, in correspondence to step S18 executed in a terminal apparatus which is the main terminal, responds to the pairing request from the terminal apparatus which is the main terminal and starts the pairing through communication by the between-terminal communication unit 18 (step S27). Then, the CPU 11 sets the communication mode of the between-terminal communication unit 18 to the stealth mode (step S28).

In correspondence to step S19 executed in the terminal apparatus which is the main terminal, the CPU 11 receives the checksum of the data from the terminal apparatus which is the main terminal via the between-terminal communication unit 18 (step S29).

Then, in correspondence to step S20 which is executed in the terminal apparatus which is the main terminal, the CPU 11 receives the data from the terminal apparatus which is the main terminal via the between-terminal communication unit 18 and stores the data in the storage unit 17 (step S30).

Thereafter, through the communication via the between-terminal communication unit 18, the CPU 11 dissolves the pairing which started in step S27 (step S31). Then, the CPU 11 calculates the checksum of the data received in step S30, compares the calculated checksum to the checksum received in step S29 and determines whether the checksums match and confirm “OK” (step S32).

If the checksums are confirmed as “NG” (step S32; NO), this indicates that the data received in step S30 has inconsistency (error) and the process proceeds to step S26.

If the checksums are confirmed as “OK” (step S32; YES), this indicates that the data received in step S30 has no inconsistency and the CPU 11 resets the terminal name of the terminal apparatus 10A itself to the regular terminal name stored in the storage unit 17 from the tentative terminal name (step S33).

Then, the CPU 11 cancels the stealth mode set in step S28 (step S34) and displays a dialog notifying the end of the first data copying process in the display unit 14 (step S35).

Thereafter, the CPU 11 resets the software (step S36) and the first data copying process ends. In the terminal apparatus which is the sub terminal in which the software is reset in step S36, after the reset, the data (the back-up image file of the main terminal) stored in the storage unit 17 in step S30 is opened and is activated as the copy of the terminal apparatus which is the main terminal.

Next, a specific example of the first data copying process performed in the terminal management system 1 will be described with reference to FIG. 4. As shown in FIG. 1, this is the case where the terminal apparatus 10A is the main terminal and the terminal apparatuses 10B, 10C and 10D are the sub terminals.

In each of the terminal apparatuses 10A, 10B, 10C and 10D, the first data copying process is started. As shown in FIG. 4, first, the terminal apparatus 10A is selected to be the main terminal in step S12 and the terminal apparatus 10A starts preparation for data transmission.

In each of the terminal apparatuses 10B, 10C and 10D, the terminal apparatus is selected to be the sub terminal in step S12, the terminal name is changed to the tentative terminal name “HT_1” in step S25 and the paring mode is started in step S25.

In the terminal apparatus 10A, existence of the terminal apparatuses 10B, 10C and 10D, each having the tentative terminal name, is confirmed in step S16 and the MAC address of the terminal apparatus 10B is obtained in step S17.

Then, as the first cycle, which is the first data copying cycle, pairing between the terminal apparatus 10A and the terminal apparatus 10B starts in steps S18 and S27, the checksum and data is transmitted to the terminal apparatus 10B from the terminal apparatus 10A in steps S19, S20, S29 and S30, and thereafter, the pairing is dissolved in steps S21 and S31.

In the terminal apparatus 10B, the checksums are confirmed as “OK” in step S32, the processing of steps S33 to S36 is executed and the name of the terminal apparatus 10B is reset to the regular terminal name. Thereby, the terminal apparatus 10B becomes the copy of the terminal apparatus 10A.

Subsequently, in the terminal apparatus 10A, existence of the terminal apparatuses 10C and 10D, each having the tentative terminal name (“HT_1”), is confirmed in step S16 and the MAC address of the terminal apparatus 10C is obtained in step S17.

Then, as the second cycle, which is the second data copying cycle, the checksum and data are transmitted to the terminal apparatus 10C from the terminal apparatus 10A in steps S18 to S21 and steps S27 to S31, similarly to the first cycle.

In the terminal apparatus 10C, the checksums are confirmed as “OK” in step S32, the processing of steps S33 to S36 is executed and the name of the terminal apparatus 10C is reset to the regular terminal name. Thereby, the terminal 10C becomes the copy of the terminal apparatus 10A.

In the terminal apparatus 10A, existence of the terminal apparatus 10D having the tentative terminal name is confirmed in step S16 and the MAC address of the terminal apparatus 10D is obtained in step S17.

Then, as the third cycle, which is the third data copying cycle, the checksum and data are transmitted to the terminal apparatus 10D from the terminal apparatus 10A in steps S18 to S21 and steps S27 to S31, similarly to the first cycle.

In the terminal apparatus 10D, the checksums are confirmed as “OK” in step S32, the processing of steps S33 to S36 is executed and the name of the terminal apparatus 10D is reset to the regular terminal name. Thereby, the terminal 10D becomes the copy of the terminal apparatus 10A.

As described above, according to the embodiment, a terminal apparatus, if it is the main terminal, determines whether terminal apparatuses which are the sub terminals, such terminal apparatuses being the sub terminals in which the data is to be copied but the data is not yet transmitted, exist through communication by the between-terminal communication unit 18 (searches for the terminal apparatuses which are communicable and determines whether terminal apparatuses which are sub terminals exist among the detected terminal apparatuses).

If it is determined that terminal apparatuses which are the sub terminals exist, the terminal apparatus which is the main terminal reads out the data from the storage unit 17 and transmits the data to one of the terminal apparatuses which are the sub terminals determined to exist via the between-terminal communication unit 18. Thereafter, the terminal apparatus which is the main terminal repeats the processing from the determination of existence of terminal apparatuses which are the sub terminals (searching for terminal apparatuses) to transmission of data.

Therefore, when copying the same data into a plurality of terminal apparatuses, a worker does not need to monitor the data copying process and does not need to create and set up the copying path of the data. Thus, the work load of a worker can be reduced, the human resource cost can be cut back, human errors can be reduced and the data copying process can be performed securely.

Moreover, because the terminal apparatus which is the main terminal repeatedly performs the processing from determining whether terminal apparatuses which are the sub terminals exist to transmitting of data, the time required for copying the data into the entire terminal apparatuses included in the terminal management system 1 can be shortened.

A terminal apparatus, if it is the sub terminal, receives the data transmitted from the terminal apparatus which is the main terminal via the between-terminal communication unit 18 and stores the data in the storage unit 17. Therefore, copying of data into a terminal apparatus which is the sub terminal can be performed easily, and a terminal apparatus can be used as the main terminal or as the sub terminal.

A terminal apparatus determines whether the terminal apparatus itself is to be the main terminal or the sub terminal according to the information input to the operating unit 12. Therefore, whether the terminal apparatus is to be used as the main terminal or the sub terminal can be set easily.

Moreover, a terminal apparatus, if it is the main terminal, determines whether terminal apparatuses which are the sub terminals having the predetermined tentative terminal name for the sub terminals exist through communication by the between-terminal communication unit 18.

Corresponding to this procedure, a terminal apparatus, if it is the sub terminal, changes the terminal name of itself to the tentative terminal name for the subterminal. Therefore, the terminal apparatus which is the main terminal can easily recognize the terminal apparatus which is the sub terminal by the predetermined tentative terminal name and can set up pairing automatically.

Further, a terminal apparatus, if it is the sub terminal, changes the terminal name of itself to the tentative terminal name and stores the regular terminal name before the change in the storage unit 17, and then, resets the terminal name of itself to the regular terminal name before the change which is stored in the storage unit 17 after receiving the data.

Therefore, the terminal apparatus which is the main terminal can easily recognize the terminal apparatus which is the sub terminal in which data copying is not yet completed by the tentative terminal name, and the terminal name of the terminal apparatus which is the sub terminal can be easily reset to the regular terminal name after the data copying process.

A terminal apparatus, if it is the main terminal, starts paring with the terminal apparatuses which are the sub terminals that are determined to exist via the between-terminal communication unit 18 and transmits the data read out from the storage unit 17 to the terminal apparatuses which are the sub terminals.

Corresponding to this procedure, a terminal apparatus, if it is the sub terminal, starts pairing with the terminal apparatus which is the main terminal via the between-terminal communication unit 18 and receives data from the terminal apparatus which is the main terminal.

Therefore, the data can be transmitted to the terminal apparatus which is the sub terminal from the terminal apparatus which is the main terminal unfailingly through the pairing.

Further, a terminal apparatus, if it is the main terminal, sets the communication mode of the between-terminal communication unit 18 to the stealth mode.

Corresponding to this procedure, a terminal apparatus, if it is the sub terminal, starts pairing with the terminal apparatus which is the main terminal and sets the communication mode of the between-terminal communication unit 18 to the stealth mode.

Therefore, in the pairing between the terminal apparatus which is the main terminal and the terminal apparatus which is the sub terminal, the terminal apparatuses are not to be the communication targets of other devices, and therefore, unnecessary processing can be avoided and security measures of communication and processing speed can be improved.

Furthermore, a terminal apparatus, if it is the main terminal, calculates the checksum of the data read out from the storage unit 17 and transmits the data and the calculated checksum to the terminal apparatuses which are the sub terminals confirmed to exist.

Corresponding to this procedure, a terminal apparatus, if it is the sub terminal, receives the data and the checksum from the terminal apparatus which is the main terminal, calculates the checksum of the received data and compares the received checksum with the calculated checksum. If the checksums to not match, the terminal apparatus which is the sub terminal waits for data and a checksum to be transmitted from the terminal apparatus which is the main terminal again.

Therefore, the terminal apparatus which is the sub terminal can detect inconsistency of the received data according to the comparison result of the checksums, and the terminal apparatus which is the sub terminal can try to receive data and a checksum again even when errors occur in data origination and communication due to temporary changes and obstacles in the communication environment.

Because the communication method of the between-terminal communication units 18 is by using Bluetooth (registered trademark) format, between-terminal communication and data copying can be performed without requiring other devices such as connection cables and access points for wireless LAN.

Specifically, in the present embodiment, the between-terminal communication units 18 of Bluetooth (registered trademark) format which is standard equipment are used as they are.

In the embodiment, the terminal apparatus 10A is the only terminal apparatus which is the main terminal. However, by including a plurality of terminal apparatuses which are the main terminals, data copying process can be executed in a parallel manner by the main terminals and the efficiency of data copying can be improved drastically.

### Second Embodiment

The second embodiment of the present invention will be described with reference to FIGS. 5 to 7A to 7B.

First, the apparatus configuration according to the embodiment will be described with reference to FIG. 5. FIG. 5 is a block diagram showing the terminal management system 2 according to the embodiment.

In the embodiment, at least one group is set in the terminal management system. If a plurality of groups are set, terminal apparatuses which are copies of the main terminal are created in each group, the main terminal being different in each group. Each group includes a terminal apparatus which is the main terminal and terminal apparatuses which are the sub terminals.

As shown in FIG. 5, the terminal management system 2 includes the terminal apparatuses 10E, 10F, 10G, 10H, 10I, 10J and 10K.

Two groups which are groups g1 and g2 are set in the terminal management system 2, for example.

The terminal apparatuses 10E, 10G, 10J and 10K belong to the group g1. In the group g1, the terminal apparatus 10E is the main terminal and the terminal apparatuses 10G, 10J and 10K are the sub terminals.

The terminal apparatuses 10F, 10H and 10I belong to the group g2. In the group g2, the terminal apparatus 10F is the main terminal and the terminal apparatuses 10H and 10I are the sub terminals.

That is, in the group g1, the data (the back-up image file) in the terminal apparatus 10E which is the main terminal is to be copied into the terminal apparatuses 10G, 10J and 10K which are the sub terminals.

In the group g2, the data (the back-up image file) in the terminal apparatus 10E which is the main terminal is to be copied into the terminal apparatuses 10H and 10I which are the sub terminals.

Here, the number of terminal apparatuses and the number of groups in the terminal management system 2, the number of main terminals and the number of sub terminals in each group are not limited to those exemplified in FIG. 5.

However, in a case where a plurality of main terminals exist in a group, the data to be copied into sub terminals from each main terminal is to be the same data among the main terminals within the group.

Moreover, the functional configuration in each of the terminal apparatuses 10E to 10K is similar to the functional configuration in the terminal apparatus 10A of the first embodiment shown in FIG. 2. However, the second data copying program is stored in the ROMs 15 of the terminal apparatuses 10E to 10K instead of the first data copying program 151.

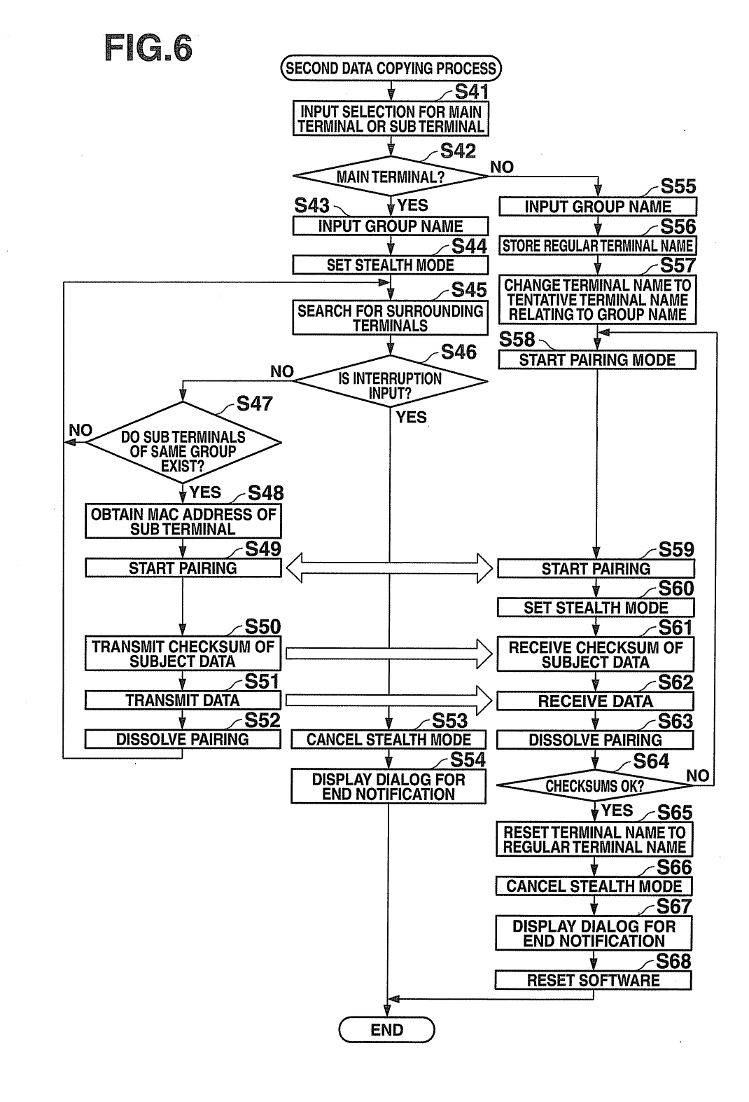

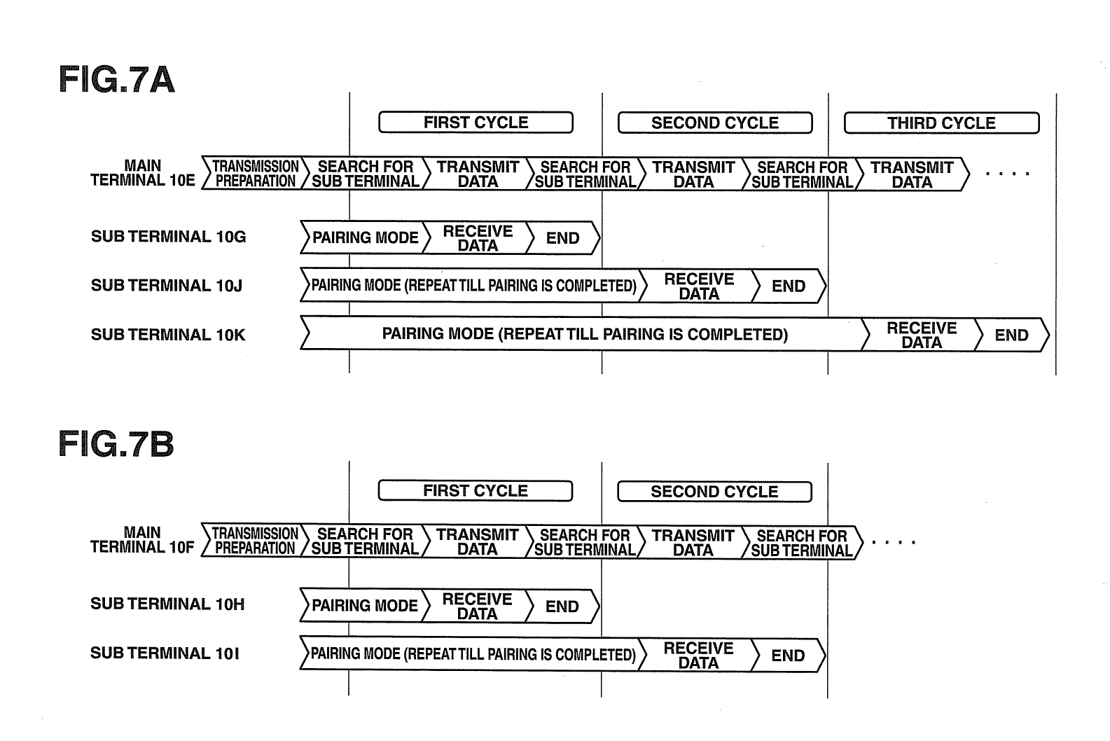

Next, operation of the terminal management system 2 will be described with reference to FIGS. 6 and 7.

FIG. 6 is a flowchart showing the second data copying process. FIG. 7A is a time chart of the data transmission procedure performed among the terminal apparatuses that belong to the group g1. FIG. 7B is a time chart of the data transmission procedure performed among the terminal apparatuses that belong to the group g2.

The second data copying process which is to be executed in each terminal apparatus in the terminal management system 2 will be described. The second data copying process is a process to transmit and copy data into terminal apparatuses which are the sub terminals that belong to a predetermined group from a terminal apparatus which is the main terminal that belongs to the predetermined group. Following description is given by taking the case where the second data copying process is executed in the terminal apparatus 10E as an example. The second data copying process is similarly executed in the terminal apparatuses 10F to 10K.

Application programs are installed and various types of settings are set in the terminal apparatuses which are the main terminals according to operation inputs performed by a delivery worker on the operating unit 12 so that the terminal apparatuses which are the main terminals are set-up to be operable, and back-up image files are created as the data of the terminal apparatuses and are respectively stored in the storage units 17.

It is assumed that the terminal apparatuses which are the sub terminals are arranged at the positions where between-terminal communication can be carried out with one another.

Further, it is assumed that the terminal names of the terminal apparatuses 10E to 10K are set to “Windows (registered trademark) CE”, for example, as the predetermined regular terminal names, the group names of the groups g1 and g2 are respectively set to “g1” and “g2” and the tentative terminal names for the sub terminals at the time of data copying is set to “HT_(group name)”, for example.

In the terminal apparatus 10E, input of an instruction to execute the second data copying process by a worker operating on the operating unit 12 being the trigger, for example, the CPU 11 executes the second data copying process in cooperation with the second data copying program which is read out from the ROM 15 and opened in the RAM 13.

While the second data copying process is being executed in the terminal apparatus 10E which is the main terminal in the group g1, the second data copying process is also executed in the terminal apparatuses 10G, 10J and 10K which are the sub terminals.

While the second data copying process is being executed in the terminal apparatus 10F which is the main terminal in the group g2, the second data copying process is also executed in the terminal apparatuses 10H and 10I which are the sub terminals.

As shown in FIG. 6, steps S41 and S42 in the second data copying process are similar to steps S11 and S12 in the first data copying process of the first embodiment.

In each group, when a terminal apparatus is selected to be the main terminal (step S42; YES), the CPU 11 of the terminal apparatus which is the main terminal receives the input of the group name of the group to which the terminal apparatus belongs by a worker operating on the operating unit 12 (step S43).

Steps S45 to S46 are similar to steps S14 to S15 in the first data copying process of the first embodiment.

If an operation instruction for interruption is not input (step S46; NO), the CPU 11 of the main terminal determines whether sub terminals having the tentative terminal name (“HT_(group name)”) of the same group corresponding to the group name input in step S43 exist among the terminal apparatuses detected in step S45 (step S47).

If there is no sub terminal having the tentative terminal name of the same group (step S47; NO), the process proceeds to step S45.

If sub terminals having the tentative terminal name of the same group exist (step S47; YES), step S48 is executed. Steps S48 to S54 are similar to steps S17 to S23 in the first data copying process of the first embodiment.

In a group, if a terminal apparatus is not selected to be the main terminal (step S42; NO), the terminal apparatus is selected to be the sub terminal and the CPU 11 of the sub terminal receives input of the group name of the group to which the sub terminal itself belongs by a worker operating on the operating unit 12 (step S55).

Step S56 is similar to step S24 in the first data copying process of the first embodiment.

Then, the CPU 11 of the sub terminal changes the terminal name thereof to the tentative terminal name (“HT_(group name)”) corresponding to the group name input in step S55 (step S57). Steps S58 to S68 are similar to steps S26 to S36 in the first data copying process of the first embodiment.

Next, a specific example of the second data copying process in the terminal management system 2 will be described with reference to FIGS. 7A and 7B.

As shown in FIG. 5, in the group g1, the terminal apparatus 10E is the main terminal and the terminal apparatuses 10G, 10J and 10K are the sub terminals, and in the group g2, the terminal apparatus 10F is the main terminal and the terminal apparatuses 10H and 10I are the sub terminals.

In each of the terminal apparatuses 10E to 10K, execution of the second data copying process is started. As shown in FIG. 7A, first, the terminal apparatus 10E is selected to be the main terminal in step S42, the group name “g1” is input in the terminal apparatus 10E in step S43 and the terminal apparatus 10E starts preparation for data transmission. The terminal apparatuses 10G, 10J and 10K are selected to be the sub terminals in step S42, the group name “g1” is input in the terminal apparatuses 10G, 10J and 10K in step S55, the terminal names of the terminal apparatuses 10G, 10J and 10K are changed to the tentative terminal name “HT_g1” in step S57 and the pairing mode is started in the terminal apparatuses 10G, 10J and 10K in step S58.

Then, in the terminal apparatus 10E, existence of the terminal apparatuses 10G, 10J and 10K having the tentative terminal name “HT_g1” is confirmed in step S47 and the MAC address of the terminal apparatus 10G is obtained in step S48.

As the first cycle, pairing between the terminal apparatus 10E and the terminal apparatus 10G is started in steps S49 and S59, a checksum and data are transmitted to the terminal apparatus 10G from the terminal apparatus 10E in steps S50, S51, S61 and S62 and the pairing is dissolved in steps S52 and S63.

In the terminal apparatus 10G, the checksums are confirmed as “OK” in step S64, the processing of steps S65 to S68 is executed and the terminal name of the terminal apparatus 10G is reset to the regular terminal name. Thereby, the terminal apparatus 10G becomes the copy of the terminal apparatus 10E.

Then, in the terminal apparatus 10E, existence of the terminal apparatuses 10J and 10K having the tentative terminal name “HT_g1” is confirmed in step S47 and the MAC address of the terminal apparatus 10J is obtained in step S48.

As the second cycle, the checksum and data are transmitted to the terminal apparatus 10J from the terminal apparatus 10E in steps S49 to S52 and in steps S59 to S63, similarly to the first cycle.

In the terminal apparatus 10J, the checksum is confirmed as “OK” in step S64, the processing of steps S65 to S68 is executed and the terminal name of the terminal apparatus 10J is reset to the regular terminal name. Thereby, the terminal apparatus 10J becomes the copy of the terminal apparatus 10E.

Then, in the terminal apparatus 10E, existence of the terminal apparatus 10K having the tentative terminal name “HT_g1” is confirmed in step S47 and the MAC address of the terminal apparatus 10K is obtained in step S48.

As the third cycle, the checksum and data are transmitted to the terminal apparatus 10K from the terminal apparatus 10E in steps S49 to S52 and in steps S59 to S63.

In the terminal apparatus 10K, the checksums are confirmed as “OK” in step S64, the processing of steps S65 to S68 is executed and the terminal name of the terminal apparatus 10K is reset to the regular terminal name. Thereby, the terminal apparatus 10K becomes the copy of the terminal apparatus 10E.

In parallel with the data copying procedure in the group g1, the data copying procedure of the group g2 is carried out.

As shown in FIG. 7B, first, the terminal apparatus 10F is selected to be the main terminal in step S42, the group name “g2” is input in the terminal apparatus 10F in step S43 and the terminal apparatus 10F starts preparation for data transmission.

The terminal apparatuses 10H and 10I are selected to be the sub terminals in step S42, the group name “g2” is input in the terminal apparatuses 10H and 10I in step S55, the terminal names of the terminal apparatuses 10H and 10I are changed to the tentative terminal name “HT_g2” in step S57 and the pairing mode is started in the terminal apparatuses 10H and 10I in step S58.

Then, in the terminal apparatus 10F, existence of the terminal apparatuses 10H and 10I having the tentative terminal name “HT_g2” is confirmed in step S47 and the MAC address of the terminal apparatus 10H is obtained in step S48.

As the first cycle, pairing between the terminal apparatus 10F and the terminal apparatus 10H is started in steps S49 and S59, a checksum and data are transmitted to the terminal apparatus 10H from the terminal apparatus 10F in steps S50, S51, S61 and S62 and the pairing is dissolved in steps S52 and S63.

In the terminal apparatus 10H, the checksums are confirmed as “OK” in step S64, the processing of steps S65 to S68 is executed and the terminal name of the terminal apparatus 10H is reset to the regular terminal name. Thereby, the terminal apparatus 10H becomes the copy of the terminal apparatus 10F.

Then, in the terminal apparatus 10F, existence of the terminal apparatus 10I having the tentative terminal name “HT_g2” is confirmed in step S47 and the MAC address of the terminal apparatus 10I is obtained in step S48.

As the second cycle, the checksum and data are transmitted to the terminal apparatus 10I from the terminal apparatus 10F in steps S49 to S52 and in steps S59 to S63, similarly to the first cycle.

In the terminal apparatus 10I, the checksums are confirmed as “OK” in step S64, the processing of steps S65 to S68 is executed and the terminal name of the terminal apparatus 10I is reset to the regular terminal name. Thereby, the terminal apparatus 10I becomes the copy of the terminal apparatus 10F.

As described above, according to the embodiment, a terminal apparatus, if it is the main terminal, determines whether terminal apparatuses which are the sub terminals having the tentative terminal name relating to the group to which the terminal apparatus which is the main terminal belongs exist through communication by the between-terminal communication unit 18.

Corresponding to this procedure, a terminal apparatus, if it is the sub terminal, changes the terminal name thereof to the tentative terminal name relating to the group to which the terminal apparatus belongs.

Therefore, the effects same as those obtained in the first embodiment can also obtained, and further, different data can be copied into the terminal apparatuses in different groups and the data copying processes of different groups can be performed in a parallel manner. Thus, data copying efficiency in the entire groups can be improved drastically.

Moreover, a terminal apparatus, if it is the main terminal, determines whether terminal apparatuses having the tentative terminal name of the group corresponding to the group name as identification information input by the operating unit 12 exist through communication by the between-terminal communication unit 18.

Corresponding to this procedure, a terminal apparatus, if it is the sub terminal, changes the terminal name thereof to the tentative terminal name of the group corresponding to the group name which is input by the operation unit 12. Therefore, the tentative terminal name of the group to which the terminal apparatus belongs can be set easily.

### Third Embodiment

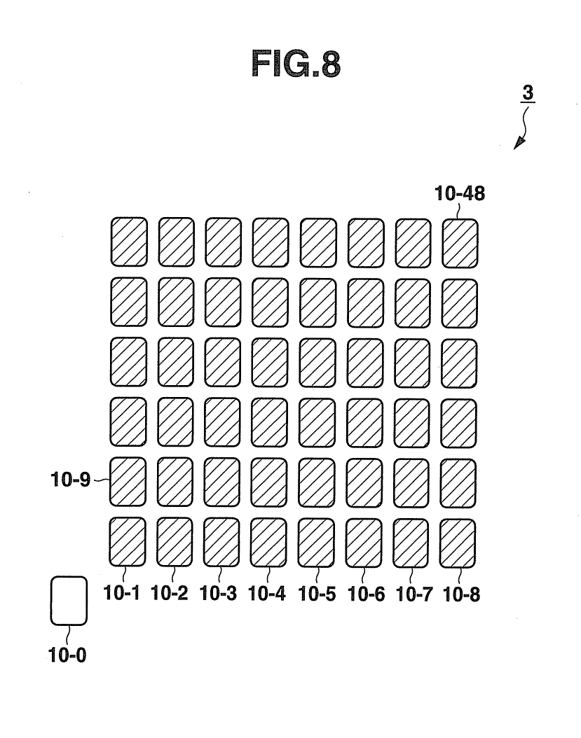

The third embodiment according to the present invention will be described with reference to FIGS. 8 to 10A and 10B.

First, the apparatus configuration according to the embodiment will be described with reference to FIG. 8.

FIG. 8 is a block diagram showing the terminal management system 3 according to the embodiment.

In the embodiment, at least one group is set in the terminal management system. If a plurality of groups are set, terminal apparatuses which are copies of a different main terminal are created in each group and the sub terminals which are copies are reused as the main terminals. Here, in the embodiment, “reused as the main terminals” means that the sub terminals which are copies are to be set as main terminals and thereafter act as main terminals.

As shown in FIG. 8, the terminal management system 3 includes the terminal apparatuses 10-0 to 10-48.

In the terminal management system 3, one group which is the group g1 is set, for example. In other words, the terminal apparatus 10-0 to 10-48 belong to the group g1.

The terminal apparatus 10-0 is the main terminal in the group g1 and the terminal apparatuses 10-1 to 10-48 are the sub terminals in the group g1.

That is, in the group g1, the data (the back-up image file) in the terminal apparatus 10-0 which is the main terminal is to be copied into the terminal apparatuses 10-1 to 10-48 which are the sub terminals.

The functional configuration in each of the terminal apparatuses 10-1 to 10-48 is similar to the functional configuration of the terminal apparatus 10A of the first embodiment shown in FIG. 2.

However, in the ROMs 15 of the terminal apparatus 10-1 to 10-48, the third data copying program is stored instead of the first data copying program 151.

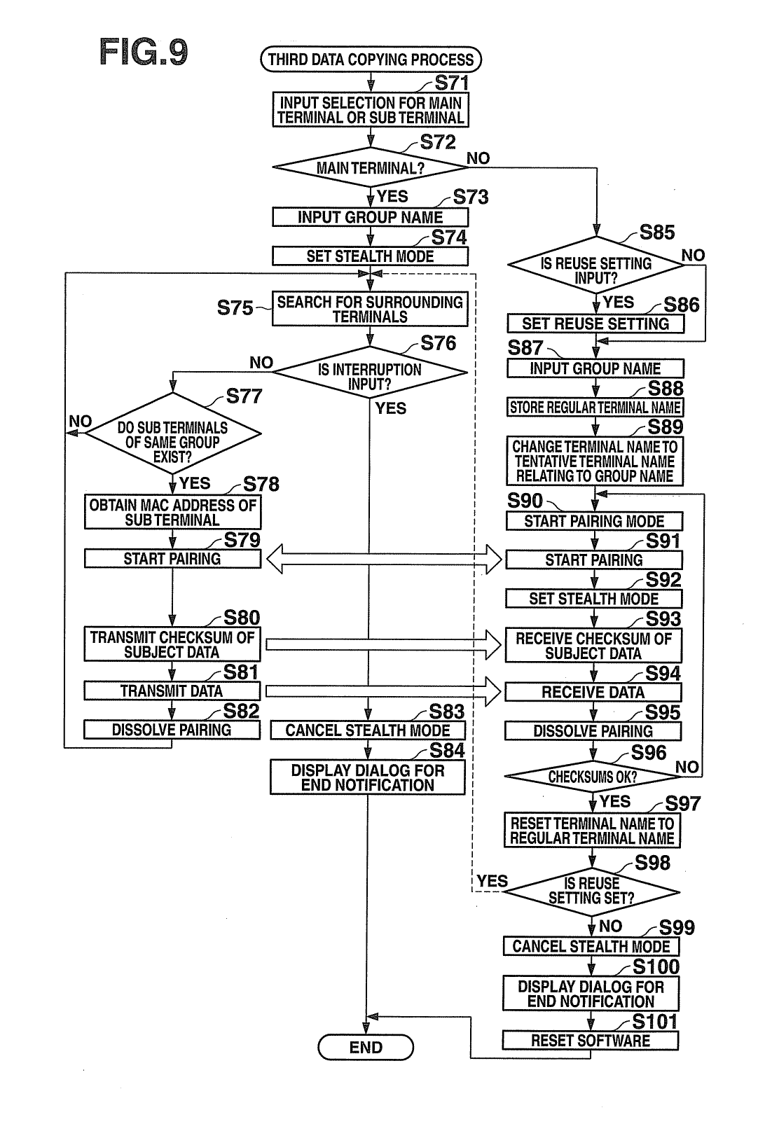

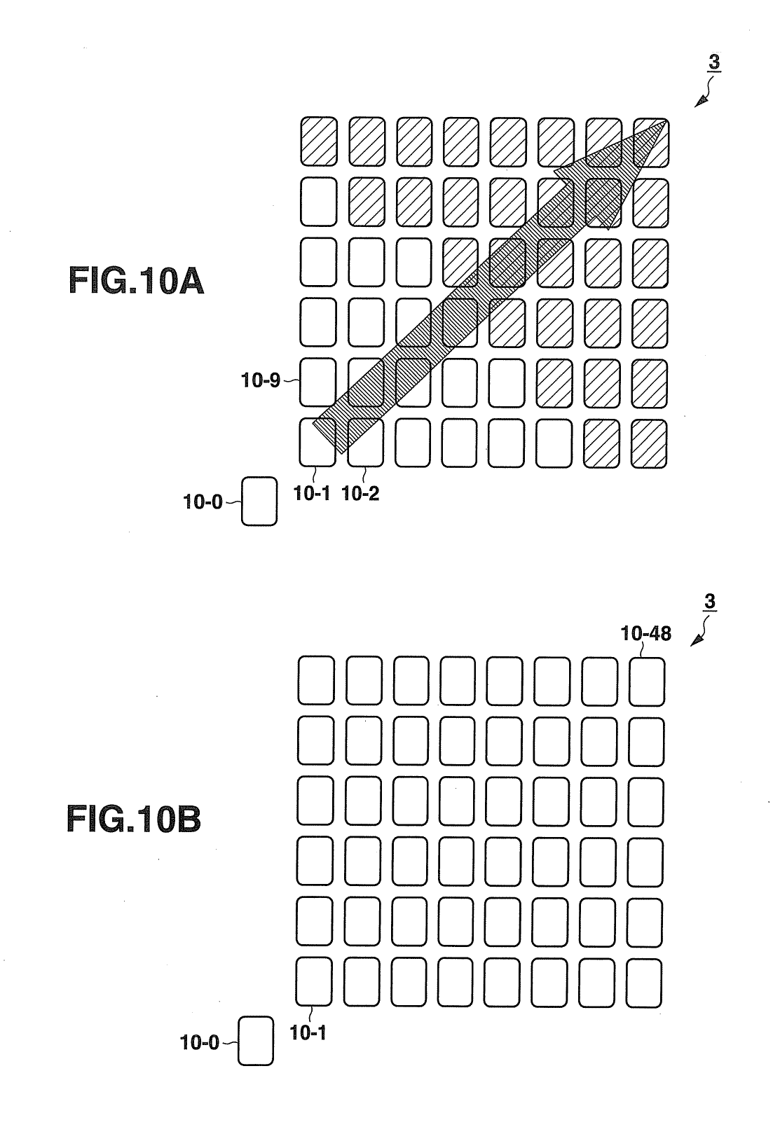

Next, operation of the terminal management system 3 will be described with reference to FIGS. 9, 10A and 10B.

FIG. 9 is a flowchart showing the third data copying process.

FIG. 10A is a diagram showing the configuration of the third terminal management system during data copying.

FIG. 10B is a diagram showing the configuration of the terminal management system 3 when data copying is completed.

The third data copying process which is executed in each of the terminal apparatuses in the terminal management system 3 will be described.

The third data copying process is a process in which data is transmitted and copied into the terminal apparatuses which are the sub terminals belonging to a predetermined group from the terminal apparatus which is the main terminal belonging to the predetermined group, and the terminal apparatuses which are the sub terminals into which the data is copied are reused as main terminals.

The following description is given by taking the case where the third data copying process is executed in the terminal apparatus 10-0. The third data copying process is executed similarly in the terminal apparatuses 10-1 to 10-48.

In advance, application programs are installed and various types of settings are set in the terminal apparatus which is the main terminal according to operation inputs performed by a delivery worker on the operating unit 12 so that the terminal apparatus which is the main terminal is set-up to be operable, and a back-up image file is created as the data of the terminal apparatus which is the main terminal and is stored in the storage unit 17.

It is assumed that the terminal apparatuses 10-0 to 10-48 are arranged at the positions where between-terminal communication can be carried out with one another.

Further, it is assumed that the terminal names of the terminal apparatuses 10-1 to 10-48 are set to “Windows (registered trademark) CE”, for example, as the predetermined regular terminal name, the group name of the group g1 is set to “g1” and the tentative terminal name for sub terminals at the time of data copying is set to “FIT (group name)”, for example.

In the terminal apparatus 10-0, input of an instruction to execute the third data copying process by a worker operating on the operating unit 12 being the trigger, for example, the CPU 11 executes the third data copying process in cooperation with the third data copying program which is read out from the ROM 15 and opened in the RAM 13.

While the third data copying process is being executed in the terminal apparatus 10-0 which is the main terminal in the group g1, the third data copying process is also executed in the terminal apparatuses 10-1 to 10-48 which are the sub terminals.

As shown in FIG. 9, steps S71 to S84 in the third data copying process are similar to steps S41 to S54 in the second data copying process of the second embodiment.

If a terminal apparatus is not selected to be the main terminal (step S72; NO), the terminal apparatus is selected to be the sub terminal and the CPU 11 determines whether a reuse setting for reusing the terminal apparatus as the main terminal after the data copying is completed in the terminal apparatus is input by a worker operating on the operation unit 12 (step S85).

If the reuse setting is input (step S85; YES), the CPU 11 sets the terminal apparatus itself to be reused (step S86). If the reuse setting is not input (step S85; NO), the process proceeds to step S87.

Steps S87 to S97 are similar to steps S55 to S65 in the second data copying process of the second embodiment.

Then, the CPU 11 determines whether the reuse setting of the terminal apparatus itself is set in step S86 (step S98).

If the reuse setting of the terminal apparatus itself is set (step S98; YES), the CPU 11 makes the terminal apparatus itself be reused as the main terminal and the process proceeds to step S75.

If the reuse setting of the terminal apparatus itself is not set (step S98; NO), the process proceeds to step S99. Steps S99 to S101 are similar to steps S66 to S68 in the second data copying process of the second embodiment.

Next, a specific example of the third data copying process in the terminal management system 3 will be described with reference to FIGS. 10A and 10B.

As shown in FIG. 8, before the third data copying process is executed, the terminal apparatus 10-0 is the main terminal and the terminal apparatuses 10-1 to 10-48 are the sub terminals in the group g1.

In each of the terminal apparatuses 10-0 to 10-48, the third data copying process is started. In step S85, it is assumed that all of the terminal apparatuses 10-1 to 10-48 which are the sub terminals have the reuse setting set therein.

First, data is copied into the terminal apparatus 10-1 which is the sub terminal from the terminal apparatus 10-0 which is the main terminal and the terminal apparatus 10-1 becomes the copy of the terminal apparatus 10-0.

Because the reuse setting is set in the terminal apparatus 10-1, the determination in step S98 is YES and the process proceeds to step S75 where the terminal apparatus 10-1 is to be reused as the main terminal. In other words, the terminal apparatus 10-1 acts as the main terminal.

Then, the data is copied into the terminal apparatus 10-9 which is the sub terminal from the terminal apparatus 10-0 which is the main terminal and the terminal apparatus 10-9 becomes the copy of the terminal apparatus 10-0. Also, the data is copied into the terminal apparatus 10-2 which is the sub terminal from the terminal apparatus 10-1 which is the main terminal and the terminal apparatus 10-2 becomes the copy of the terminal apparatus 10-1.

Similarly, the terminal apparatuses 10-2 and 10-9 are reused as the main terminals.

In such way, as shown in FIG. 10A, the number of terminal apparatuses which act as main terminals in the terminal management system 3 increases in a manner such as 1→2→4→8 . . . .

Further, as shown in FIG. 10B, all of the terminal apparatuses 10-0 to 10-48 become the main terminals and the third data copying process ends in all of the terminal apparatuses 10-0 to 10-48.

As described above, according to the embodiment, the effects same as those obtained in the second embodiment can also be obtained. Further, a terminal apparatus, if it is the sub terminal, sets itself (set to be reused) so as to act as the main terminal after storing the data received from a terminal apparatus which is the main terminal in the storage unit 17.

Therefore, because the number of terminal apparatuses which act as main terminals can increase as time passes, the data copying processes involving different main terminals can be carried out in a parallel manner and the time required for data copying in the entire terminal apparatuses in the terminal management system 3 can be shortened. Thus, data copying efficiency can be improved drastically.

Furthermore, a terminal apparatus, if it is the sub terminal, determines whether the setting information (reuse setting) for acting as the main terminal is input by the operating unit 12 after storing the data received from a terminal apparatus which is the main terminal in the storage unit 17. If the setting information is input, the terminal apparatus sets itself so as to act as the main terminal.

Therefore, a terminal apparatus can be set to act as the main terminal easily after acting as the sub terminal.

In the above description, the example where the ROMs 15 are used as the computer readable medium of the program of the present invention is described. However, the present invention is not limited to this example.

As for other computer readable medium, non-volatile memories (storage unit 17) such as flash memories and portable recording mediums such as CD-ROMs can be applied.

Moreover, as a medium which provides data of programs of the present invention, a carrier wave can be applied.

Here, descriptions in the above embodiments are examples of the terminal apparatuses and programs of the present invention, and the present invention is not limited to the examples.

In the third embodiment, at least one terminal apparatus group is set in the terminal management system 3. However, the present invention is not limited to such example.

For example, in the terminal management system 3, the configuration may be such that groups are not set, the group name is not input and there is one type of tentative terminal name as in the first embodiment.

Further, in the above embodiments, the communication method between terminals is by using Bluetooth (registered trademark) format. However, the present invention is not limited to such communication method. For example, other communication method by which the terminals can communication in a wireless manner such as Zigbee (registered trademark), UWB (Ultra Wide Band) or the like can be applied.

Furthermore, in the above embodiment, inputs of whether a terminal apparatus is to be the main terminal or the sub terminal, the group name and the reuse setting are performed via the operating unit 12 while the first, the second or the third data copying process is executed. However, the present invention is not limited to such operation.

For example, information including information on whether a terminal apparatus is to be the main terminal or the sub terminal, the group name and information on whether the reuse setting is set can be created and stored in the storage unit 17 in advance before executing the first, the second or the third data copying process, and the CPU 11 of each terminal apparatus may read out the information stored in the storage unit 17 to make judgments while the data copying process is executed.

Moreover, with regard to detail configurations and detail operations of the components in the terminal management systems 1, 2 and 3 in the above embodiment, they may be modified arbitrarily within the scope of the present invention.

In the above, the embodiments of the present invention are described. However, the scope of the present invention is not limited to the above described embodiments, and the scope of the present invention includes the scope of the claimed and equivalents thereof.

The entire disclosure of Japanese Patent Application No. 2012-156057 filed on Jul. 12, 2012 including description, claims, drawings and abstract are incorporated herein by reference in its entirety.

What is claimed is:

1. A terminal apparatus, comprising:
a communication unit which performs a wireless communication with another terminal apparatus;
a determination unit which determines whether a terminal apparatus which is a sub terminal, into which data subject to copying is to be copied, exists through the communication via the communication unit, the terminal apparatus which is the sub terminal being a terminal apparatus to which the data is not yet transmitted, if the terminal apparatus is a main terminal from which the data is copied; and
a control unit which reads out the data from a storage unit and transmits the data to the terminal apparatus which is the sub terminal determined to exist via the communication unit if the determination unit determines that the terminal apparatus which is the sub terminal exists,
wherein
processing from determining of existence of the terminal apparatus which is the sub terminal by the determination unit to transmitting of the data by the control unit is repeatedly performed.

2. The terminal apparatus as claimed in claim 1, wherein
if the terminal apparatus is the sub terminal, the control unit receives the data from a terminal apparatus which is the main terminal via the communication unit and stored the data in the storage unit.

3. The terminal apparatus as claimed in claim 2, wherein
if the terminal apparatus is the sub terminal, the control unit sets the terminal apparatus so as to act as the main terminal after storing the data received from the terminal apparatus which is the main terminal in the storage unit.

4. The terminal apparatus as claimed in claim 3 further comprising:
a first operating unit which receives an input of setting information to make the terminal apparatus act as the main terminal, wherein
if the terminal apparatus is the sub terminal, the control unit determines whether the setting information is input to the first operating unit and makes the terminal apparatus act as the main terminal if the setting information is input, after storing the data received from the terminal apparatus which is the main terminal in the storage unit.

5. The terminal apparatus as claimed in claim 1 further comprising:
a second operating unit which receives an input of information indicating whether the terminal apparatus is the main terminal or the sub terminal, wherein
the control unit determines whether the terminal apparatus is the main terminal or the sub terminal according to the information input to the second operating unit.

6. The terminal apparatus as claimed in claim 1, wherein
if the terminal apparatus is the main terminal, the determination unit determines whether a terminal apparatus which is the sub terminal having a predetermined tentative terminal name for the sub terminal exists through the communication via the communication unit, and
if the terminal apparatus is the sub terminal, the control unit changes a terminal name of the terminal apparatus to the tentative terminal name for the sub terminal.

7. The terminal apparatus as claimed in claim 1, wherein
at least one group to which the terminal apparatus belongs is set,
if the terminal apparatus is the main terminal, the determination unit determines whether a terminal apparatus which is the sub terminal having a tentative terminal name relating to a group to which the terminal apparatus belongs exist through the communication via the communication unit, and
if the terminal apparatus is the sub terminal, the control unit changes a terminal name of the terminal apparatus to the tentative terminal name relating to the group to which the terminal apparatus belongs.

8. The terminal apparatus as claimed in claim 7 further comprising:
a third operating unit which receives an input of identification information of the group to which the terminal apparatus belongs, wherein
if the terminal apparatus is the main terminal, the determination unit determines whether a terminal apparatus which is the sub terminal having a tentative terminal name relating to the group corresponding to the identification information input to the third operating unit exist through the communication via the communication unit, and
if the terminal apparatus is the sub terminal, the control unit changes the terminal name of the terminal apparatus to the tentative terminal name relating to the group corresponding to the identification information input to the third operating unit.

9. The terminal apparatus as claimed in claim 6, wherein
if the terminal apparatus is the sub terminal, the control unit changes the terminal name of the terminal apparatus to the tentative terminal name and stores the terminal name before the change in the storage unit, and the control unit resets the terminal name of the terminal apparatus to the terminal name before the change stored in the storage unit after the data is received.

10. The terminal apparatus as claimed in claim 1, wherein
if the terminal apparatus is the main terminal, the control unit starts pairing with the terminal apparatus which is the sub terminal determined to exist via the communication unit and transmits the read data to the terminal apparatus which is the sub terminal, and
if the terminal apparatus is the sub terminal, the control unit starts pairing with a terminal apparatus which is the main terminal via the communication unit and receives the data from the terminal apparatus which is the main terminal.

11. The terminal apparatus as claimed in claim 10, wherein
if the terminal apparatus is the main terminal, the control unit sets a communication mode of the communication unit to a stealth mode, and
if the terminal apparatus is the sub terminal, the control unit set the communication mode of the communication unit to the stealth mode when the pairing with the terminal apparatus which is the main terminal is started.

12. The terminal apparatus as claimed in claim 1, wherein
if the terminal apparatus is the main terminal, the control unit calculates a checksum of the read data and transmits the data and the calculated checksum to the terminal apparatus which is the sub terminal determined to exist, and
if the terminal apparatus is the sub terminal, the control unit receives the data and the checksum from a terminal apparatus which is the main terminal, calculates a checksum of the received data, compares the received checksum to the calculated checksum and waits for data and a checksum to be transmitted again from the terminal apparatus which is the main terminal if the checksums do not match.

13. The terminal apparatus as claimed in claim 1, wherein the communication unit uses a Bluetooth (registered trademark) format for the communication.

14. A non-transitory computer readable medium which stores a program for making a computer execute a process, the process comprising:
performing a wireless communication between one terminal apparatus and another terminal apparatus;
if the one terminal apparatus is a main terminal from which data is copied, determining whether a terminal apparatus which is a sub terminal into which the data subject to copying is to be copied exist through the communication with the second terminal apparatus, the terminal apparatus which is the sub terminal being a terminal apparatus to which the data is not yet transmitted;
if the terminal apparatus which is the sub terminal is determined to exist, reading the data from a storage unit and transmitting the data to the terminal apparatus which is the sub terminal determined to exist, and
repeatedly performing processing from the determining whether the terminal apparatus which is the sub terminal exists to the transmitting of the data.
